(19) United States
(12) Patent Application Publication
(10) Pub. No.: US 2025/0081109 A1
(43) Pub. Date: Mar. 6, 2025

(54) WIRELESS NETWORK APPARATUS AND COMMUNICATION METHOD

(71) Applicant: REALTEK SEMICONDUCTOR CORP., HSINCHU (TW)

(72) Inventors: ZHAO-MING LI, Jiangsu Province (CN); MENG-ZHOU SHEN, Jiangsu Province (CN); JING ZHANG, Jiangsu Province (CN)

(21) Appl. No.: 18/672,110

(22) Filed: May 23, 2024

(30) Foreign Application Priority Data
Aug. 31, 2023 (CN) 202311118680.2

(51) Int. Cl. H04W 52/02

(52) U.S. Cl. CPC H04W 52/0238; H04W 52/0216; H04W 52/0229

(57) ABSTRACT

A wireless network apparatus and a communication method are provided. The wireless network apparatus transmits signals through a channel and an access point, and includes a radio frequency transceiver and a control circuit. The control circuit is configured to execute a communication procedure, which includes processes of: activating the radio frequency transceiver to receive a beacon sent by the access point through the channel, and determining whether or not the radio frequency transceiver receives the beacon; determining, in response to determining that the radio frequency transceiver does not receive the beacon, whether or not the channel satisfies a predetermined condition by an energy detection circuit; and deactivating, in response to determining that the channel satisfies the predetermined condition, the radio frequency transceiver.

### CROSS-REFERENCE TO RELATED PATENT APPLICATION

This application claims the benefit of priority to China Patent Application No. 202311118680.2, filed on Aug. 31, 2023, in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a power-saving configuration of a wireless network apparatus, and more particularly to a wireless network apparatus and a communication method in which a radio frequency transceiver is deactivated to reduce power consumption via energy detection during a time when the radio frequency transceiver is activated for receiving a beacon, thereby saving power and increasing an operation time of the wireless network apparatus when the power is supplied by a battery.

### BACKGROUND OF THE DISCLOSURE

A wireless network apparatus (otherwise referred to as a station) can transmit signals through a channel and an access point (AP). In a power save mode, the wireless network apparatus periodically activates a radio frequency transceiver to receive a beacon sent by the access point through the channel, so as to determine whether or not there are cached data packets to be sent at the access point. Power consumption of the radio frequency transceiver can be high, and the longer the radio frequency transceiver is activated to receive the beacon, the more power the wireless network apparatus consumes. As a result, an operation time of the wireless network apparatus is reduced when the power is supplied by a battery.

### SUMMARY OF THE DISCLOSURE

In response to the above-referenced technical inadequacy, the present disclosure provides a wireless network apparatus and a communication method in which a radio frequency transceiver is deactivated to reduce power consumption via energy detection during a time when the radio frequency transceiver is activated for receiving a beacon, thereby saving power and increasing an operation time of the wireless network apparatus when the power is supplied by a battery.

In order to solve the above-mentioned problem, one of the technical aspects adopted by the present disclosure is to provide a wireless network apparatus. The wireless network apparatus transmits signals through a channel and an access point, and includes a radio frequency transceiver and a control circuit. The control circuit is coupled to the radio frequency transceiver, and is configured to execute a communication procedure. The communication procedure includes processes of: activating the radio frequency transceiver to receive a beacon sent by the access point through the channel, and determining whether or not the radio frequency transceiver receives the beacon; determining, in response to determining that the radio frequency transceiver does not receive the beacon, whether or not the channel satisfies a predetermined condition by an energy detection circuit; and deactivating, in response to determining that the channel satisfies the predetermined condition, the radio frequency transceiver.

In order to solve the above-mentioned problem, another one of the technical aspects adopted by the present disclosure is to provide a communication method, which is applied to a wireless network apparatus that transmits signals through a channel and an access point. The communication method includes processes of: activating a radio frequency transceiver of the wireless network apparatus to receive a beacon sent by the access point through the channel, and determining whether or not the radio frequency transceiver receives the beacon; determining, in response to determining that the radio frequency transceiver does not receive the beacon, whether or not the channel satisfies a predetermined condition by an energy detection circuit; and deactivating, in response to determining that the channel satisfies the predetermined condition, the radio frequency transceiver.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a wireless network apparatus according to one embodiment of the present disclosure;

FIG. 2 is a flowchart of a communication method according to a first embodiment of the present disclosure;

FIG. 3 is a flowchart of the communication method according to a second embodiment of the present disclosure;

FIG. 4 is a timing diagram showing activation and deactivation of a radio frequency transceiver in the communication method according to the second embodiment of the present disclosure;

FIG. 5 is a flowchart of the communication method according to a third embodiment of the present disclosure; and

FIG. 6 is a timing diagram showing activation and deactivation of the radio frequency transceiver in the communication method according to the third embodiment of present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

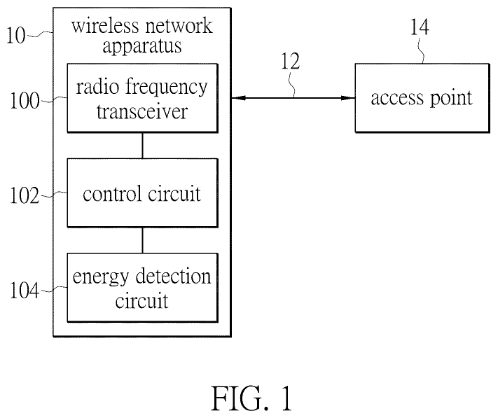

Reference is made to FIG. 1, which is a functional block diagram of a wireless network apparatus according to one embodiment of the present disclosure. As shown in FIG. 1, a wireless network apparatus 10 can transmit signals through a channel 12 and an access point 14, and includes a radio frequency transceiver 100 and a control circuit 102 coupled to the radio frequency transceiver 100. Specifically, the channel 12 can be a wireless channel, and the access point 14 can be a wireless access point. After a communication connection is established between the wireless network apparatus 10 and the access point 14, the wireless network apparatus 10 is able to transmit and receive data packets by the radio frequency transceiver 100. However, when there is no data packet to be transmitted or received, the wireless network apparatus 10 may enter a power save mode to save power by deactivating the radio frequency transceiver 100.

In the power save mode, the wireless network apparatus 10 periodically activates the radio frequency transceiver 100 to receive a beacon (not shown in FIG. 1) sent by the access point 14 through the channel 12, so as to determine whether or not there are cached data packets to be sent at the access point 14. Generally, the control circuit 102 of the wireless network apparatus 10 activates the radio frequency transceiver 100 at a target beacon transmission time (TBTT) for receiving the beacon sent by the access point 14. However, the present disclosure is not limited thereto. In addition, after receiving the beacon, the control circuit 102 will deactivate the radio frequency transceiver 100. Since other network apparatuses can also transmit signals through the channel 12, a time point at which the radio frequency transceiver 100 actually receives the beacon may be delayed when numerous network apparatuses in the surrounding environment compete for use of the channel 12. Hence, there can be a significant time difference between the actual time point and the target beacon transmission time.

Furthermore, the beacon may be lost due to collision with the signals transmitted by other network apparatuses. Under this circumstance, the radio frequency transceiver 100 cannot receive the beacon. Since power consumption of the radio frequency transceiver 100 can be high, the longer the radio frequency transceiver 100 is activated, the more power the wireless network apparatus 10 consumes. As a result, an operation time of the wireless network apparatus 10 is reduced when the power is supplied by a battery. In order to solve this technical problem, the control circuit 102 of the wireless network apparatus 10 is configured to execute a communication method of the present disclosure.

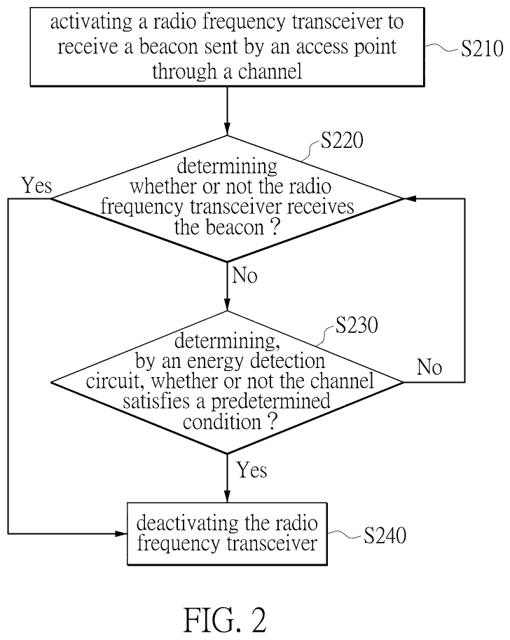

Reference is made to FIG. 2, which is a flowchart of the communication method according to a first embodiment of the present disclosure. As shown in FIG. 2, the communication method of the first embodiment includes the following steps.

Step S210: activating a radio frequency transceiver to receive a beacon sent by an access point through a channel.

Step S220: determining whether or not the radio frequency transceiver receives the beacon. If not, the communication method proceeds to step S230. If yes, the communication method proceeds to step S240.

Step S230: determining, by an energy detection circuit, whether or not the channel satisfies a predetermined condition. As shown in FIG. 1, in response to determining that the radio frequency transceiver 100 does not receive the beacon, the control circuit 102 determines whether or not the channel 12 satisfies the predetermined condition by an energy detection circuit 104. If yes, the communication method proceeds to step S240. If not, the communication method returns to step S220.

Step S240: deactivating the radio frequency transceiver. That is to say, in response to determining that the channel 12 satisfies the predetermined condition, the control circuit 102 will deactivate the radio frequency transceiver 100. In addition, in response to determining that the radio frequency transceiver 100 receives the beacon, the control circuit 102 will also deactivate the radio frequency transceiver 100.

Specifically, the control circuit 102 can be implemented by cooperation of hardware (e.g., a processor and a memory), software, and/or firmware. In the embodiments of the present disclosure, the communication method can be implemented as a computer procedure. In other words, the control circuit 102 is configured to execute a communication procedure that includes the above-mentioned steps. Moreover, the energy detection circuit 104 is coupled to the control circuit 102, and can be a clear channel assessment (CCA) circuit that detects a use state of the channel 12 based on energy. The control circuit 12 is able to detect signal energy of the channel 12 by the energy detection circuit 104, and determines whether or not the channel 12 is in an idle state according to the signal energy of the channel 12.

For example, in the present embodiment, if the signal energy of the channel 12 is greater than a predetermined energy threshold, the channel 12 will be determined as not being in the idle state. Theoretically, if the channel 12 is in the idle state, the access point 14 will be allowed to use the channel 12 for sending the beacon to the wireless network apparatus 10. Hence, when the channel 12 is determined as being in the idle state and a continuation time of the idle state reaches a predetermined time threshold, the control circuit 102 can determine that the beacon sent by the access point 14 is already lost, thereby deactivating the radio frequency transceiver 100. In other words, the predetermined condition mentioned above indicates that the channel is in the idle state and the continuation time of the idle state reaches the predetermined time threshold.

For ease of illustration, in the present embodiment, a duration of time in which the radio frequency transceiver 100 is activated for receiving the beacon is defined as an active time of the radio frequency transceiver 100. It should be noted that, conventionally, a timeout threshold is set after the target beacon transmission time. In the conventional technology, the radio frequency transceiver 100 is deactivated if the beacon is received before the active time of the radio frequency transceiver 100 reaches the timeout threshold, and the radio frequency transceiver 100 will not be re-activated for receiving the beacon sent by the access point 14 until the next target beacon transmission time. Furthermore, in the conventional technology, the radio frequency transceiver 100 is also deactivated if the beacon is not received before the active time of the radio frequency transceiver 100 reaches the timeout threshold, and the radio frequency transceiver 100 will not be re-activated for receiving the beacon sent by the access point 14 until the next target beacon transmission time.

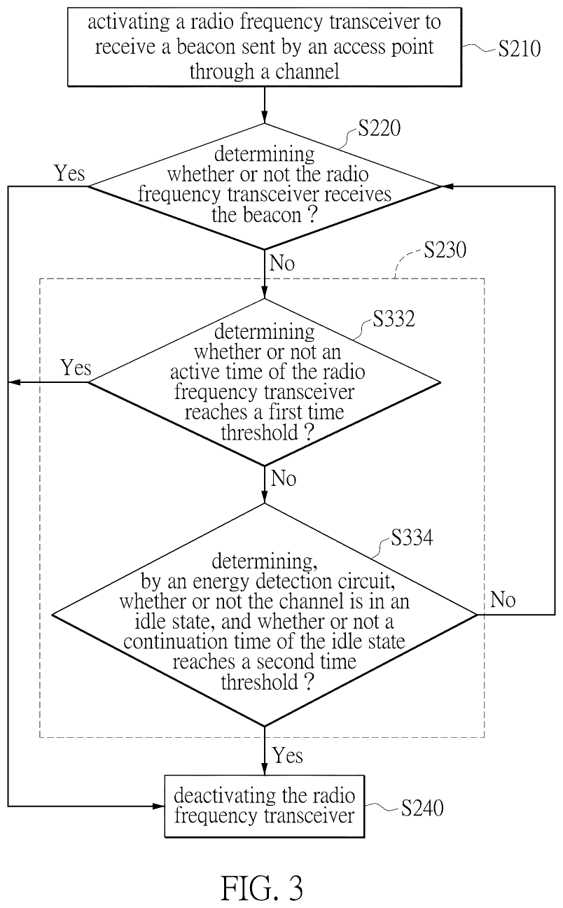

Taking the conventional technology into consideration, a second implementation of the communication method is provided in the present disclosure. Reference is made to FIG. 3, which is a flowchart of the communication method according to a second embodiment of the present disclosure. The steps in FIG. 3 that are the same as those in FIG. 2 will not be reiterated herein. As shown in FIG. 3, in the communication method of the second embodiment, step S230 can include the following steps.

Steps S332: determining whether or not an active time of the radio frequency transceiver reaches a first time threshold. If not, the communication method proceeds to step S334. If yes, the communication method proceeds to step S240. That is to say, in response to determining that the active time of the radio frequency transceiver 100 reaches the first time threshold, the control circuit 102 also deactivates the radio frequency transceiver 100.

Step S334: determining, by the energy detection circuit, whether or not the channel is in the idle state, and whether or not the continuation time of the idle state reaches a second time threshold. If yes, the communication method proceeds to step S240. If not, the communication method returns to step S220. That is to say, in response to determining that the channel 12 is not in the idle state or the continuation time of the idle state does not reach the second time threshold, the control circuit 102 will re-execute the step of determining whether or not the radio frequency transceiver 100 receives the beacon.

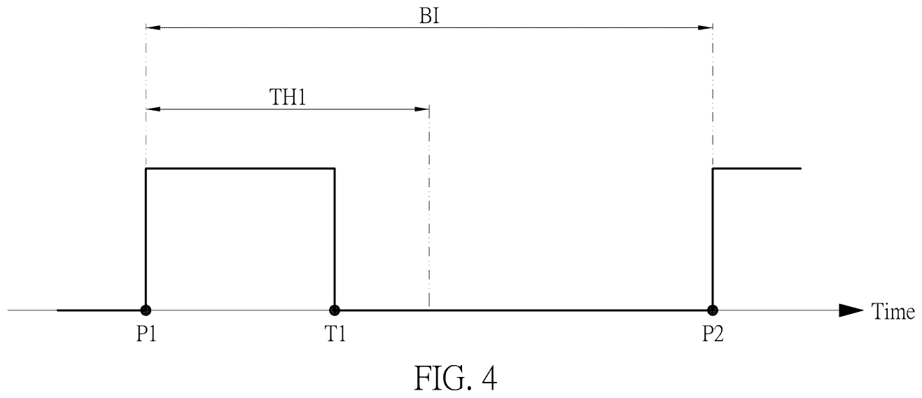

Specifically, the first time threshold of the present embodiment refers to the above-mentioned timeout threshold (e.g., 20 ms), but the present disclosure is not limited thereto. In the present embodiment, the second time threshold is less than the first time threshold. Reference is made to FIG. 4, which is a timing diagram showing activation and deactivation of the radio frequency transceiver in the communication method according to the second embodiment of the present disclosure. For ease of illustration, a logic high level and a logic low level are used to respectively represent an activated state and a deactivated state of the radio frequency transceiver 100 in the present embodiment.

As shown in FIG. 4, the control circuit 102 can execute the communication method of the second embodiment at each target beacon transmission time. However, the present disclosure is not limited thereto. That is to say, the control circuit 102 can activate the radio frequency transceiver 100 at a target beacon transmission time P1 for receiving the beacon sent by the access point 14. In an example where the beacon is already lost (i.e., the radio frequency transceiver 100 cannot receive the beacon), before the active time of the radio frequency transceiver 100 reaches a first time threshold TH1, the control circuit 102 will deactivate the radio frequency transceiver 100 if the control circuit 102 determines at a time point T1 that the channel 12 is in the idle state and the continuation time of the idle state reaches the second time threshold (not shown in FIG. 4). The radio frequency transceiver 100 will not be re-activated for receiving the beacon sent by the access point 14 until a subsequent target beacon transmission time P2.

Based on the above description, in the situation where the beacon is already lost, the radio frequency transceiver 100 will remain to be activated in the conventional technology, and will not be deactivated until the active time of the radio frequency transceiver 100 reaches the first time threshold TH1. However, in the present embodiment, the channel 12 can be timely detected as being idle for a period of time via energy detection, such that keeping the radio frequency transceiver 100 in the activated state is unnecessary. Hence, without waiting for the active time of the radio frequency transceiver 100 to reach the first time threshold TH1, the control circuit 102 can deactivate the radio frequency transceiver 100 at an earlier time to reduce power consumption. In this way, power is saved, and an operation time of the wireless network apparatus 10 can be increased when the power is supplied by a battery. In other words, in the situation where the beacon is already lost, the communication method in the second embodiment of the present disclosure can shorten the active time of the radio frequency transceiver 100 as compared with the conventional technology.

As mentioned above, when there are other network apparatuses in the surrounding environment that compete for use of the channel 12, the time point at which the radio frequency transceiver 100 actually receives the beacon may be delayed, and is thus later than the target beacon transmission time. That is to say, when there is severe channel competition, it is likely that the channel 12 is not available for the access point 14 to send the beacon to the wireless network apparatus 10 until a later time. As a result, the radio frequency transceiver 100 may receive the beacon only after its active time reaches the first time threshold TH1. In the communication method of the present embodiment, the channel 12 can be timely detected as being in a busy state (i.e., the channel 12 is not in the idle state or the continuation time of the idle state does not reach the time threshold) via energy detection, which suggests that the access point 14 sends the beacon only at a later time. Therefore, the radio frequency transceiver 100 is kept in the activated state, so as to increase the chance of the radio frequency transceiver 100 receiving the beacon.

It should be noted that, in order to periodically activate the radio frequency transceiver 100, a target time interval BI is defined between two adjacent ones of the target beacon transmission time. Theoretically, the further away from the target beacon transmission time, the lower the chance of the radio frequency transceiver 100 receiving the beacon. Therefore, in the communication method of the present embodiment, the target time interval BI after the current target beacon transmission time is further divided into a plurality of windows, and different time thresholds are set for these windows to determine whether or not the channel 12 is constantly in the busy state.

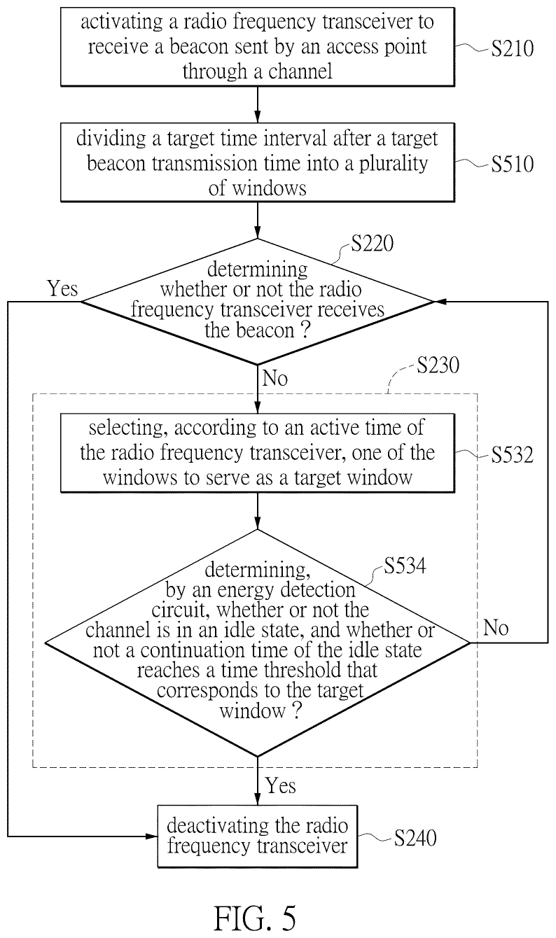

When there is severe channel competition, in order to increase the chance of the radio frequency transceiver 100 receiving the beacon, a third implementation of the communication method is provided in the present disclosure. Reference is made to FIG. 5, which is a flowchart of the communication method according to a third embodiment of the present disclosure. The steps in FIG. 5 that are the same as those in FIG. 2 will not be reiterated herein. It should be noted that, in the communication method of the third embodiment, the control circuit 102 is limited to activating the radio frequency transceiver 100 at the target beacon transmission time for receipt of the beacon sent by the access point 14. As shown in FIG. 5, before step S220, the communication method of the third embodiment can further include the step below.

Step S510: dividing a target time interval after the target beacon transmission time into a plurality of windows.

In the communication method of the third embodiment, step S230 can include the following steps.

Step S532: selecting, according to the active time of the radio frequency transceiver, one of the windows to serve as a target window.

Step S534: determining, by the energy detection circuit, whether or not the channel is in the idle state, and whether or not the continuation time of the idle state reaches the time threshold that corresponds to the target window. If yes, the communication method proceeds to step S240. If not, the communication method returns to step S220. That is to say, in response to determining that the channel 12 is not in the idle state or the continuation time of the idle state does not reach the time threshold that corresponds to the target window, the control circuit 102 will re-execute the step of determining whether or not the radio frequency transceiver 100 receives the beacon.

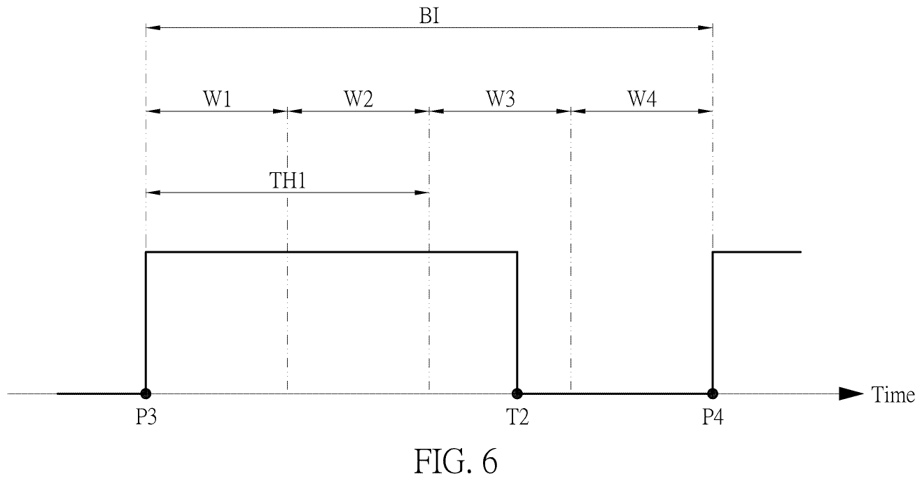

Reference is made to FIG. 6, which is a timing diagram showing activation and deactivation of the radio frequency transceiver in the communication method according to the third embodiment of present disclosure. As shown in FIG. 6, the control circuit 102 activates the radio frequency transceiver 100 at a target beacon transmission time P3 for receiving the beacon sent by the access point 14, and the target time interval BI after the target beacon transmission time P3 is divided into four windows W1 to W4. For ease of illustration, in the present embodiment, a length of time of the window W1 and the window W2 is exemplified as being equal to the above-mentioned first time threshold TH1.

In addition, for the window that is closer to the target beacon transmission time P3, the control circuit 102 sets the corresponding time threshold to be longer, so as to reduce the chance of misjudgment during said window. For example, the time threshold that corresponds to the window W1 is 3 ms, the time threshold that corresponds to the window W2 is 2 ms, the time threshold that corresponds to the window W3 is 1.5 ms, and the time threshold that corresponds to the window W4 is 1 ms. However, the present disclosure is not limited thereto.

In an example where the channel competition is severe, when the radio frequency transceiver 100 does not receive the beacon and its active time is in the window W1, the control circuit 102 will select the window W1 as the target window, and determine whether or not the channel 12 is in the idle state and whether or not the continuation time of the idle state reaches 3 ms by the energy detection circuit 104. If the channel 12 at this time is not in the idle state or the continuation time of the idle state does not reach 3 ms, the control circuit 102 will keep the radio frequency transceiver 100 in the activated state, so as to increase the chance of the radio frequency transceiver 100 receiving the beacon.

Similarly, when the radio frequency transceiver 100 does not receive the beacon and its active time is in the window W2, the control circuit 102 will select the window W2 as the target window, and determine whether or not the channel 12 is in the idle state and whether or not the continuation time of the idle state reaches 2 ms by the energy detection circuit 104. If the channel 12 at this time is not in the idle state or the continuation time of the idle state does not reach 2 ms, the control circuit 102 will also keep the radio frequency transceiver 100 in the activated state, so as to increase the chance of the radio frequency transceiver 100 receiving the beacon.

If the radio frequency transceiver 100 receives the beacon at a time point T2, the control circuit 102 will deactivate the radio frequency transceiver 100, and will not re-activate the radio frequency transceiver 100 for receiving the beacon sent by the access point 14 until a subsequent target beacon transmission time P4. Hence, in the situation where the channel competition is severe, instead of deactivating the radio frequency transceiver 100 when the active time of the radio frequency transceiver 100 reaches the first time threshold TH1 as in the conventional technology, the radio frequency transceiver 100 is kept in the activated state in the present embodiment, so as to increase the chance of the radio frequency transceiver 100 receiving the beacon.

In the situation where the beacon is already lost, the communication method of the second embodiment can shorten the active time of the radio frequency transceiver 100 as compared with the conventional technology. In the situation where the channel competition is severe, the communication method of the third embodiment can prolong the active time of the radio frequency transceiver 100 as compared with the conventional technology. In other words, as compared with the conventional technology, the communication method of the present disclosure is able to adaptively adjust the active time of the radio frequency transceiver 100 according to different situations.

### Beneficial Effects of the Embodiments

In conclusion, in the wireless network apparatus and the communication method provided by the present disclosure, during a time when the radio frequency transceiver is activated for receiving the beacon, the radio frequency transceiver can be deactivated to reduce power consumption via energy detection, thereby saving power and increasing an operation time of the wireless network apparatus when the power is supplied by a battery.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A wireless network apparatus, which transmits signals through a channel and an access point, the wireless network apparatus comprising:
a radio frequency transceiver; and
a control circuit coupled to the radio frequency transceiver, wherein the control circuit is configured to execute a communication procedure, and the communication procedure includes processes of:
activating the radio frequency transceiver to receive a beacon sent by the access point through the channel, and determining whether or not the radio frequency transceiver receives the beacon;
determining, in response to determining that the radio frequency transceiver does not receive the beacon, whether or not the channel satisfies a predetermined condition by an energy detection circuit; and
deactivating, in response to determining that the channel satisfies the predetermined condition, the radio frequency transceiver.

2. The wireless network apparatus according to claim 1, wherein the communication procedure further includes:
deactivating, in response to determining that the radio frequency transceiver receives the beacon, the radio frequency transceiver.

3. The wireless network apparatus according to claim 2, wherein the process of determining whether or not the channel satisfies the predetermined condition by the energy detection circuit includes:
determining whether or not an active time of the radio frequency transceiver reaches a first time threshold; and
determining, in response to determining that the active time of the radio frequency transceiver does not reach the first time threshold, whether or not the channel is in an idle state, and whether or not a continuation time of the idle state reaches a second time threshold by the energy detection circuit.

4. The wireless network apparatus according to claim 3, wherein the communication procedure further includes:
deactivating, in response to determining that the active time of the radio frequency transceiver reaches the first time threshold, the radio frequency transceiver; and
re-executing, in response to determining that the channel is not in the idle state or the continuation time of the idle state does not reach the second time threshold, the process of determining whether or not the radio frequency transceiver receives the beacon.

5. The wireless network apparatus according to claim 2, wherein the control circuit activates the radio frequency transceiver at a target beacon transmission time to receive the beacon sent by the access point through the channel, and the communication procedure further includes:
dividing a target time interval after the target beacon transmission time into a plurality of windows, wherein the windows respectively correspond to a plurality of time thresholds.

6. The wireless network apparatus according to claim 5, wherein the process of determining whether or not the channel satisfies the predetermined condition by the energy detection circuit includes:
selecting, according to an active time of the radio frequency transceiver, one of the windows to serve as a target window; and
determining, by the energy detection circuit, whether or not the channel is in an idle state, and whether or not a continuation time of the idle state reaches the time threshold that corresponds to the target window.

7. The wireless network apparatus according to claim 6, wherein the communication procedure further includes:
re-executing, in response to determining that the channel is not in the idle state or the continuation time of the idle state does not reach the time threshold that corresponds to the target window, the process of determining whether or not the radio frequency transceiver receives the beacon.

8. A communication method, which is applied to a wireless network apparatus that transmits signals through a channel and an access point, the communication method comprising:
activating a radio frequency transceiver of the wireless network apparatus to receive a beacon sent by the access point through the channel, and determining whether or not the radio frequency transceiver receives the beacon;
determining, in response to determining that the radio frequency transceiver does not receive the beacon, whether or not the channel satisfies a predetermined condition by an energy detection circuit; and
deactivating, in response to determining that the channel satisfies the predetermined condition, the radio frequency transceiver.

9. The communication method according to claim 8, further comprising:
deactivating, in response to determining that the radio frequency transceiver receives the beacon, the radio frequency transceiver.

10. The communication method according to claim 9, wherein the process of determining whether or not the channel satisfies the predetermined condition by the energy detection circuit includes:
determining whether or not an active time of the radio frequency transceiver reaches a first time threshold; and
determining, in response to determining that the active time of the radio frequency transceiver does not reach the first time threshold, whether or not the channel is in an idle state, and whether or not a continuation time of the idle state reaches a second time threshold by the energy detection circuit.

11. The communication method according to claim 10, further comprising:
deactivating, in response to determining that the active time of the radio frequency transceiver reaches the first time threshold, the radio frequency transceiver; and
re-executing, in response to determining that the channel is not in the idle state or the continuation time of the idle state does not reach the second time threshold, the process of determining whether or not the radio frequency transceiver receives the beacon.

12. The communication method according to claim 9, wherein a control circuit of the wireless network apparatus activates the radio frequency transceiver at a target beacon transmission time to receive the beacon sent by the access point through the channel, and the communication method further comprises:
dividing a target time interval after the target beacon transmission time into a plurality of windows, wherein the windows respectively correspond to a plurality of time thresholds.

13. The communication method according to claim 12, wherein the process of determining whether or not the channel satisfies the predetermined condition by the energy detection circuit includes:
selecting, according to an active time of the radio frequency transceiver, one of the windows to serve as a target window; and
determining, by the energy detection circuit, whether or not the channel is in an idle state, and whether or not a continuation time of the idle state reaches the time threshold that corresponds to the target window.

14. The communication method according to claim 13, further comprising:
re-executing, in response to determining that the channel is not in the idle state or the continuation time of the idle state does not reach the time threshold that corresponds to the target window, the process of determining whether or not the radio frequency transceiver receives the beacon.
